(19) United States
(12) Patent Application Publication
(10) Pub. No.: US 2018/0269765 A1
(43) Pub. Date: Sep. 20, 2018

(54) HALBACH ARRAY ASSEMBLY

(71) Applicant: Otis Elevator Company, Farmington, CT (US)

(72) Inventors: Richard N. Fargo, Plainville, CT (US); Wojciech Szelag, Poznan (PL); Cezary Jedryczka, Lniano (PL); Adam Marian Myszkowski, Ostrow Wlkp. (PL); Zbigniew Piech, Cheshire, CT (US)

(73) Assignee: Otis Elevator Company, Farmington, CT (US)

(21) Appl. No.: 15/547,611

(22) PCT Filed: Feb. 2, 2016
(86) PCT No.: PCT/US2016/016069

§ 371 Date: Jul. 31, 2017

Related U.S. Application Data
(60) Provisional application No. 62/111,314, filed on Feb. 3, 2015.

(51) Int. Cl. H02K 41/03

(52) U.S. Cl. CPC H02K 41/031

(57) ABSTRACT

A Halbach array assembly has a magnetic layer that includes a plurality of permanent magnets and a structural layer attached to a top side of the magnetic layer. The structural layer includes a plurality of rods that support the magnetic layer. The Halback array assembly further includes a plurality of clamps that attach to the structural layer, providing an attachment point for the Halbach array assembly.

### BACKGROUND

Embodiments relate generally to an elevator system and, more specifically, to a magnetic assembly including at least one Halbach array and method for assembling the Halbach array.

The construction of a Halbach array can be challenging. Typically, the array has a large number of magnets with strong attraction forces. These forces can cause the magnets to move suddenly, making assembly difficult. Glued connections of magnets to structures of the Halbach array do not provide a level of integrity required to hold the magnets in place. Glue can degrade over time, causing a connection to weaken. Further, the attracting forces of the magnets can gradually stress the glued connection.

### BRIEF DESCRIPTION

According to an exemplary embodiment, a magnetic assembly comprises a first magnetic layer that includes a first plurality of permanent magnets arranged in a first Halbach array, a second magnetic layer that includes a second plurality of permanent magnets arranged in a second Halbach array, wherein the first magnetic layer and the second magnetic layer are separated by a space, a structural compression member attached to a first outer side of the first magnetic layer and a second outer side of the second magnetic layer, the structural compression member comprises a plurality of arms that support the magnetic layer; and a plurality of tension members that attach to the structural layer.

According to another exemplary embodiment, a method of forming a magnetic assembly comprising forming a first magnetic layer that includes a first plurality of permanent magnets arranged in a first Halbach array, forming a second magnetic layer that includes a second plurality of permanent magnets arranged in a second Halbach array, wherein the first magnetic layer and the second magnetic layer are separated by a space, attaching a structural compression member to a first outer side of the first magnetic layer and a second outer side of the second magnetic layer, the structural compression member comprises a plurality of arms that support the magnetic layer, and placing a plurality of tension members within the structural layer.

In addition to one or more of the features described above or below, or as an alternative, further embodiments of the apparatus may include the first magnetic layer and the second magnetic layer disposed on either side of a primary part.

In addition to one or more of the features described above or below, or as an alternative, further embodiments of the apparatus may include the first magnetic layer with a plurality of pole magnets with angled surfaces that provide a cantilevered fit for a pole magnet, wherein the pole magnet is disposed between the plurality of pole magnets.

In addition to one or more of the features described above or below, or as an alternative, further embodiments of the apparatus may include the first magnetic layer further comprises a ferrous plank disposed between the plurality of pole magnets, forming an outer surface of the first magnetic layer.

In addition to one or more of the features described above or below, or as an alternative, further embodiments of the apparatus may include the second magnetic layer includes an opposing plurality of pole magnets with angled surfaces that provide a cantilevered fit for an opposing pole magnet, where the opposing pole magnet is disposed between the opposing plurality of pole magnets.

In addition to one or more of the features described above or below, or as an alternative, further embodiments of the apparatus may include the plurality of pole magnets, the longitudinal magnet, the opposing plurality of pole magnets, and the opposing longitudinal magnet creates a clockwise flux pattern.

In addition to one or more of the features described above or below, or as an alternative, further embodiments of the apparatus may include a plurality of caps form at least one side of the magnetic layer, and prevent shifting of the plurality of permanent magnets.

In addition to one or more of the features described above or below, or as an alternative, further embodiments of the method may include the first magnetic layer and the second magnetic layer disposed on either side of a primary part.

In addition to one or more of the features described above or below, or as an alternative, further embodiments of the method may include the first magnetic layer with a plurality of pole magnets with angled surfaces that provide a cantilevered fit for a pole magnet, wherein the pole magnet is disposed between the plurality of pole magnets.

In addition to one or more of the features described above or below, or as an alternative, further embodiments of the method may include the first magnetic layer further comprises a ferrous plank disposed between the plurality of pole magnets, forming an outer surface of the first magnetic layer.

In addition to one or more of the features described above or below, or as an alternative, further embodiments of the method may include the second magnetic layer includes an opposing plurality of pole magnets with angled surfaces that provide a cantilevered fit for an opposing pole magnet, where the opposing pole magnet is disposed between the opposing plurality of pole magnets.

In addition to one or more of the features described above or below, or as an alternative, further embodiments of the method may include the plurality of pole magnets, the longitudinal magnet, the opposing plurality of pole magnets, and the opposing longitudinal magnet creates a clockwise flux pattern.

In addition to one or more of the features described above or below, or as an alternative, further embodiments of the method may include a plurality of caps form at least one side

### BRIEF DESCRIPTION OF THE DRAWINGS

FIG. 1 depicts a multicar ropeless elevator system in an exemplary embodiment;

FIG. 2 illustrates an assembled Halbach array in accordance with one exemplary embodiment of the invention;

FIG. 3 illustrates an exploded view of a Halbach array in accordance with one exemplary embodiment;

FIG. 4 shows a portion of the magnetic array of the Halbach array in accordance with one exemplary embodiment; and

FIG. 5 shows a electromagnetically active parts of a double-sided linear motor in accordance with one exemplary embodiment.

### DETAILED DESCRIPTION

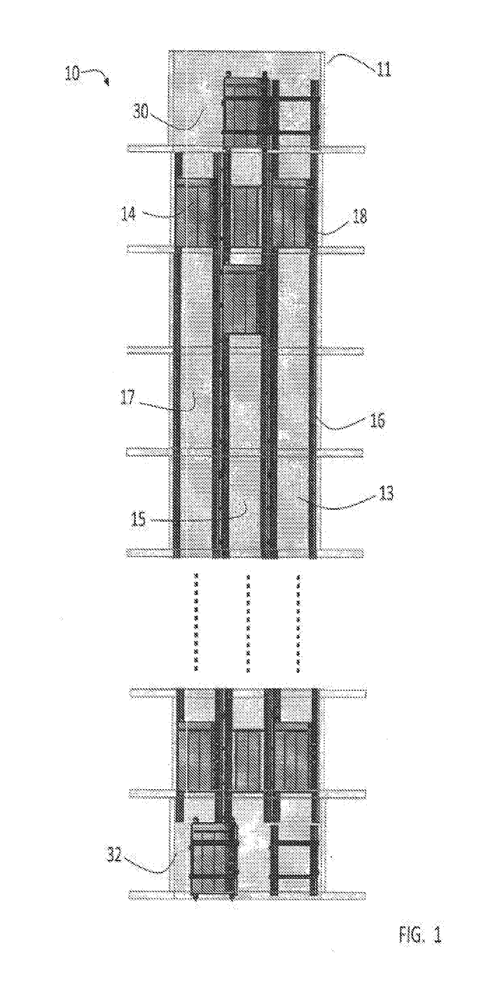

FIG. 1 depicts a multicar, self-propelled elevator system 10 in an exemplary embodiment. Elevator system 10 includes a hoistway 11 having a plurality of lanes 13, 15 and 17. While three lanes are shown in FIG. 1, it is understood that embodiments may be used with multicar, self-propelled elevator systems have any number of lanes. In each lane 13, 15, 17, cars 14 travel in one direction, i.e., up or down. For example, in FIG. 1 cars 14 in lanes 13 and 15 travel up and cars 14 in lane 17 travel down. One or more cars 14 may travel in a single lane 13, 15, and 17. In other embodiments, cars 14 may travel in both directions in a lane.

Above the top floor is an upper transfer station 30 to impart horizontal motion to elevator cars 14 to move elevator cars 14 between lanes 13, 15 and 17. It is understood that upper transfer station 30 may be located at the top floor, rather than above the top floor. Below the first floor is a lower transfer station 32 to impart horizontal motion to elevator cars 14 to move elevator cars 14 between lanes 13, 15 and 17. It is understood that lower transfer station 32 may be located at the first floor, rather than below the first floor. Although not shown in FIG. 1, one or more intermediate transfer stations may be used between the first floor and the top floor. Intermediate transfer stations are similar to the upper transfer station 30 and lower transfer station 32.

Cars 14 are propelled using a linear motor system having a primary, fixed portion 16 and a secondary, moving portion 18. The primary portion 16 includes windings or coils mounted at one or both sides of the lanes 13, 15 and 17. The primary portion 16 creates a traveling (or motion inducing) magnetic field when energized by a power source, e.g. inverter. Secondary portion 18 includes permanent magnets mounted to one or both sides of cars 14. The secondary portion 18 can have permanent magnets arranged in a Halbach array or some other configuration that includes a non-simple alternating configuration of magnets. The secondary portion 18 can be a simple ferromagnetic plate with magnetic saliency, having teeth or bumps that become magnetic poles. In one embodiment, a linear motor may be arranged with a stationary primary part and a movable secondary part. Alternatively, in another embodiment, the linear motor may be arranged with a movable primary part and a stationary secondary part. In yet other embodiments, the secondary portion 18 mounted on car 14 includes coils and the primary portion 16 includes permanent magnets. The portion with coils is supplied with drive signals to control movement of cars 14 in their respective lines.

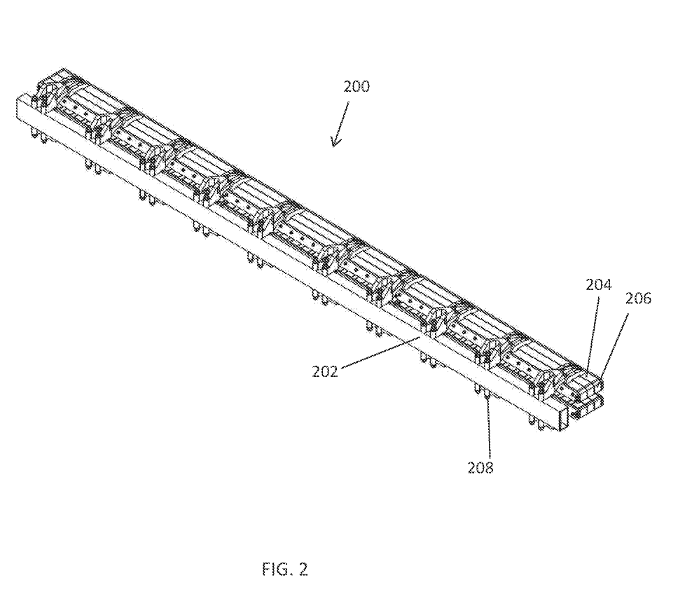

FIG. 2 illustrates a Halbach array assembly 200 in accordance with one embodiment. In this embodiment, the Halbach array assembly 200 provides the secondary portion 18 of the linear motor system. The primary portion 16 is energized to create the magnetic field to induce motion of the secondary portion 18. The Halbach array assembly 200 comprises a plurality of structural compression members 202 affixed to a structural layer 204. A plurality of tension members 208 are attached to the structural layer 204 and extend through the structural layer 204. A magnetic layer 206 is attached to a bottom side of the structural layer 204.

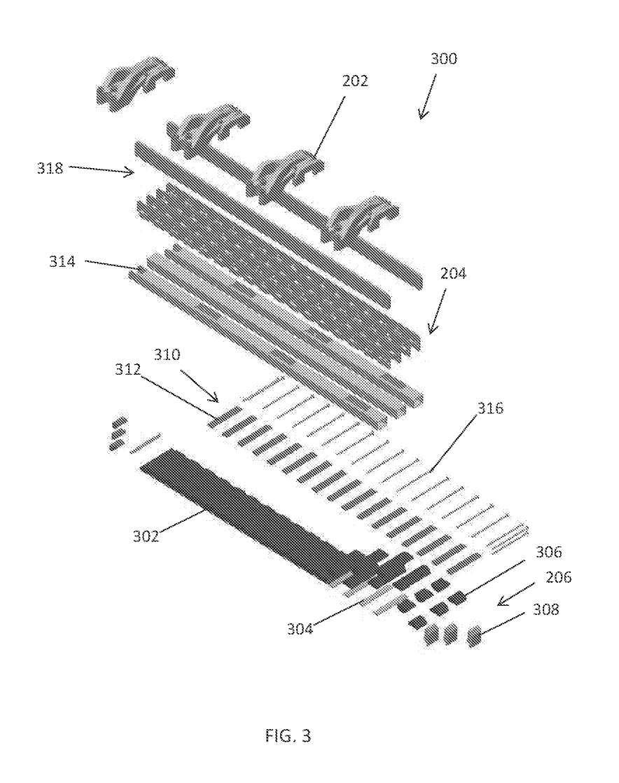

As shown in FIG. 3, the Halbach array assembly 200 comprises a plurality of structural compression members 202, a structural layer 204, and a magnetic layer 206. The magnetic layer 206 forms a bottom side 302 of the Halbach array assembly 200. The magnetic layer 206 comprises a plurality of non-ferrous (e.g., fiberglass) planks 304 that form a bottom of the Halbach array assembly 200. The plurality of permanent magnets 306 are attached on top of the plurality of fiberglass planks 304. A plurality of non-ferrous (e.g., fiberglass) caps 308 form a side of the magnetic layer 206. A plurality of ferrous (e.g., steel) planks 310 are placed on a top side 312 of the magnetic layer 206 to protect the plurality of permanent magnets 306 and provide additional structural support. The ferrous planks 310 carry a portion of the magnetic field, enhancing the magnetic field in an air gap located between the structural layer 204 and the magnetic layer 206.

The top side 312 of the magnetic layer 206 is attached to the structural layer 204, further strengthening the magnetic layer 206 and providing adjustability of the magnetic layer 206. The structural layer 204 comprises a plurality of connection members 314 held together by arms 316 extending through the plurality of connection members 314. Furthermore, a plurality of shims 318 are disposed between the plurality of connection members 314 to provide further adjustability of the magnetic layer 206. The plurality of structural compression members 202 attaches to the an outer side of the magnetic layer 206, further strengthening the magnetic layer 206 and providing an attachment point on the Halbach array assembly 200.

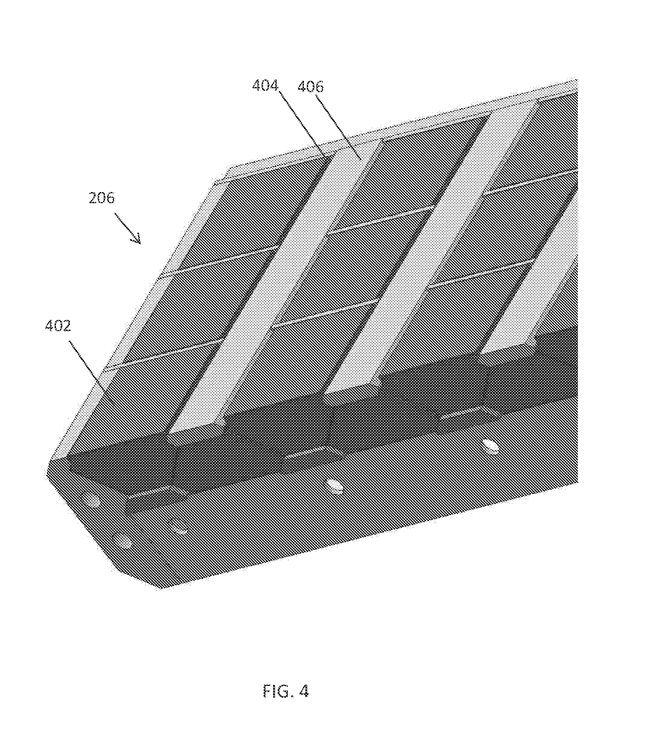

FIG. 4 illustrates the magnetic layer 206 in accordance with one embodiment. Each magnet 402 of the plurality of permanent magnets 306 is substantially trapezoidal shaped, with a groove 404 to accommodate a fiberglass plank 406. Each magnet 402 is rotated 180 degrees with respect to an adjacent magnet 408, forming a side with the fiberglass plank 406. The substantially trapezoidal shape of each magnet 402 of the plurality of permanent magnets 306 allows for the plurality of permanent magnets 306 to align with the fiberglass plank 406.

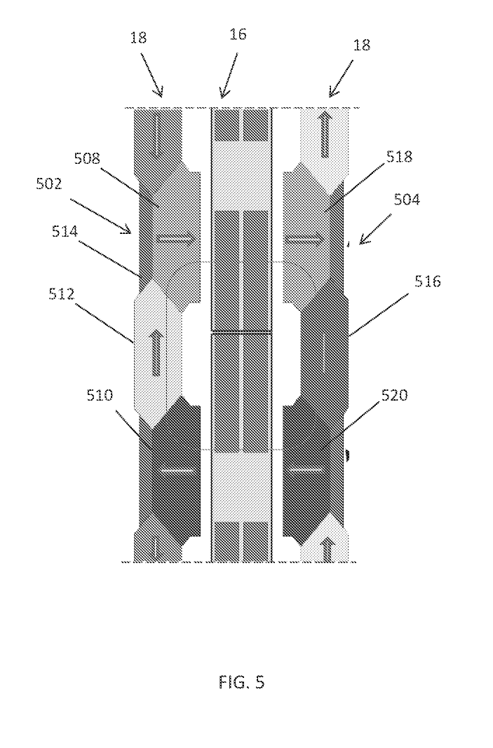

FIG. 5 illustrates a setup of electromagnetically active parts in a double-sided linear motor, with secondary parts assembled into respective Halbach arrays. In this embodiment, the secondary portion 18 has a first magnetic layer 502 and a second magnetic layer 504. The first magnetic layer 502 and the second magnetic layer 504 are assembled as Halbach arrays. However, in another embodiment, the secondary portion may be single-sided with a single magnetic layer. The first portion 16 is arranged between the first magnetic layer 502 and the second magnetic layer 504 of the secondary portion 18. The primary portion 16 comprises a linear motor primary part and winding coils within the first portion 16. The first magnetic layer 502 comprises first and second pole magnets 508, 510. The first and second pole magnets 508, 510 comprise angled surfaces that provide a cantilevered fit for a longitudinal magnet 512 disposed between the first and second pole magnets 508, 510. A ferrous plank 514 is disposed between the first and second pole magnets 508, 510, forming an outer surface of the first magnetic layer 502.

The first and second pole magnets 508, 510 are magnetized and arranged so that a magnetic field flows substantially perpendicular to an outer surface of the first magnetic layer 502. The first and second pole magnets 508, 510 are magnetized to create a magnetic field in opposite directions. In this example, the first pole magnet 508 creates a magnetic field toward the first portion 16. The second pole magnet 510 creates a magnetic field away from first portion 16. Longitudinal magnet 512 creates a magnetic field toward first pole magnet 508. In this embodiment, the polarity of adjacent magnets alternates.

On the opposing side of the first portion 16, the second magnetic layer 504 of secondary portion 18 comprises an opposing longitudinal magnet 516 positioned between opposing first and second pole magnets 518, 520. Pole magnet 508 and opposing first pole magnet 518 are magnetized in the same, first direction. Pole magnet 510 and opposing secondary pole magnet 520 are magnetized in the same, second direction. The second direction is different than the first direction.

The magnetization and orientation of the first and second pole magnets 508, 510, the longitudinal magnet 512, the opposing first and second pole magnets 518, 520, and the opposing longitudinal magnet 516 creates a clockwise flux pattern. The ferrous metal plank 514 provides further direction of the clockwise flux pattern. The ferrous metal plank 514 directs the flux pattern toward the longitudinal magnet 516, providing an increase in flux intensity. In addition, as the second magnetic layer 514 produces flux and the flux is directed to first magnetic layer 502, the ferrous metal plank prevents the magnetic flux from traveling beyond the first magnetic layer 502. The magnetic flux is directed upward toward the longitudinal magnet 512, with the magnet 508 directing the magnetic flux toward the second magnetic layer 502. Similarly, the first magnetic layer 504 produces flux and directs the flux to the second magnetic layer 514, to create a circular flux pattern. In operation, the flux can induce motion of an elevator car, for example.

While the disclosure has been described in detail in connection with only a limited number of embodiments, it should be readily understood that the invention is not limited to such disclosed embodiments. Rather, the disclosure can be modified to incorporate any number of variations, alterations, substitutions or equivalent arrangements not heretofore described, but which are commensurate with the scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

1. A magnetic linear motor assembly comprising:
a first magnetic layer that includes a first plurality of permanent magnets arranged in a first Halbach array;
a second magnetic layer that includes a second plurality of permanent magnets arranged in a second Halbach array, wherein the first magnetic layer and the second magnetic layer are separated by a space;
a primary portion mounted in the space, the primary portion comprising a plurality of motor segments, the motor segments are electrically energized to create flux, the flux is directed between the first plurality of permanent magnets and toward the second plurality of permanent magnets to create a circular pattern;
a structural compression member attached to a first outer side of the first magnetic layer and a second outer side of the second magnetic layer, the structural compression member comprises a plurality of arms that support the magnetic layer; and
a plurality of tension members that attach to the structural layer.

2. The magnetic assembly of claim 1, wherein the first magnetic layer and the second magnetic layer disposed on either side of a primary part.

3. The magnetic assembly of claim 2, wherein the first magnetic layer includes a plurality of pole magnets with angled surfaces that provide a cantilevered fit for a pole magnet, wherein the pole magnet is disposed between the plurality of pole magnets.

4. The magnetic assembly of claim 3, wherein the first magnetic layer further comprises a ferrous plank disposed between the plurality of pole magnets, forming an outer surface of the first magnetic layer.

5. The magnetic assembly of claim 2, wherein the second magnetic layer includes an opposing plurality of pole magnets with angled surfaces that provide a cantilevered fit for an opposing pole magnet, where the opposing pole magnet is disposed between the opposing plurality of pole magnets.

6. The magnetic assembly of claim 5, wherein the plurality of pole magnets, the longitudinal magnet, the opposing plurality of pole magnets, and the opposing longitudinal magnet creates a clockwise flux pattern.

7. The magnetic assembly of claim 1, wherein a plurality of caps form at least one side of the magnetic layer, and prevent shifting of the plurality of permanent magnets.

8. A method of forming a magnetic linear motor assembly comprising:
forming a first magnetic layer that includes a first plurality of permanent magnets arranged in a first Halbach array;
forming a second magnetic layer that includes a second plurality of permanent magnets arranged in a second Halbach array, wherein the first magnetic layer and the second magnetic layer are separated by a space;
mounting a primary portion in the space, the primary portion comprising a plurality of motor segments, the motor segments are electrically energized to create flux, the flux is directed between the first plurality of permanent magnets and toward the second plurality of permanent magnets to create a circular pattern;
attaching a structural compression member to a first outer side of the first magnetic layer and a second outer side of the second magnetic layer, the structural compression member comprises a plurality of arms that support the magnetic layer; and
placing a plurality of tension members within the structural layer.

9. The method of claim 8, wherein the first magnetic layer and the second magnetic layer disposed on either side of a primary part.

10. The method of claim 9, wherein the first magnetic layer includes a plurality of pole magnets with angled surfaces that provide a cantilevered fit for a pole magnet, wherein the pole magnet is disposed between the plurality of pole magnets.

11. The method of claim 9, wherein the first magnetic layer further comprises a ferrous plank disposed between the plurality of pole magnets, forming an outer surface of the first magnetic layer.

12. The method of claim 11, wherein the second magnetic layer includes an opposing plurality of pole magnets with angled surfaces that provide a cantilevered fit for an opposing pole magnet, where the opposing pole magnet is disposed between the opposing plurality of pole magnets.

13. The method of claim 8, wherein the plurality of pole magnets, the longitudinal magnet, the opposing plurality of pole magnets, and the opposing longitudinal magnet creates a clockwise flux pattern.
